(19) United States
(12) Patent Application Publication
(10) Pub. No.: US 2009/0090293 A1
(43) Pub. Date: Apr. 9, 2009

(54) VEHICLE EMERGENCY EXIT MARKING SYSTEM

(76) Inventor: Dennis Santay, Crown Point, IN (US)

Correspondence Address: OVERHAUSER LAW OFFICES, LLC;DOCKETING DEPARTMENT, 737 W. GREEN MEADOWS DRIVE, SUITE 300, GREENFIELD, IN, 46140, US

(21) Appl. No.: 12/241,777

(22) Filed: Sep. 30, 2008

Related U.S. Application Data
(60) Provisional application No. 60/977,133, filed on Oct. 3, 2007.

(51) Int. Cl. G08B 7/00; G08B 5/00; G08B 6/00

(52) U.S. Cl. 116/28 R; 297/228.1; 116/205

(57) ABSTRACT

A marking device for vehicle seats located adjacent emergency exits includes a panel associated with a cover for a seat. For example, seat covers for the upright back of school bus seats include a strip panel coupled between two facing panels. The strip panel is adapted to cover the top and opposite ends of the seat back and the two facing panels are adapted to cover the front and rear faces of the seat back. The strip panel portion of seat covers for seats located adjacent an emergency exit include a tactile feature. The tactile feature distinguishes emergency exit row seats from seats from those seats that are not located adjacent an emergency exit.

### CROSS-REFERENCE TO RELATED APPLICATIONS

This application claims the benefit of U.S. Provisional Patent Application No. 60/977,133, filed Oct. 3, 2007, and titled VEHICLE EMERGENCY EXIT MARKING SYSTEM, which is incorporated herein by reference.

### BACKGROUND AND SUMMARY

The present invention relates to vehicle safety systems, and particularly, to marking devices for locating vehicle emergency exits. The present invention may comprise one or more of the following features or combinations thereof.

Vehicles such as buses, passenger aircraft, and passenger trains typically have one or more emergency exits in addition to the primary exits. Such exits are often located between or above occupant seats and may include, for example, side doors, specially opening side windows, or ceiling hatches. In low light or smoky environments, or in the event of a visual impairment, occupants may have difficulty identifying the general location of emergency exits. As used herein, an “emergency exit” is defined to include a primary exit.

An illustrative embodiment of a marking device for bus seats located adjacent emergency exits includes a panel associated with a cover for a seat. Seat covers for the upright back of school bus seats typically include a strip panel coupled between two facing panels. The strip panel is adapted to cover the top, aisle side, and wall side of the seat back and the two facing panels are adapted to cover the front and rear faces of the seat back. The strip panel portion of seat covers for seats located adjacent an emergency exit include a tactile feature. The tactile feature distinguishes emergency exit row seats from those seats that are not located adjacent an emergency exit. A marking device according to the invention advantageously expedites identification of the general location of emergency exits for vision impaired individuals and for others in the event visibility is limited due to low light and/or smoke.

These and additional features of the disclosure will become apparent to those skilled in the art upon consideration of the following detailed description of the illustrative embodiments.

### BRIEF DESCRIPTION OF THE DRAWINGS

FIG. 1 illustrates a side perspective view of a first section of school bus seating having an emergency exit side door and seat back and barrier covers having a tactile feature according to the present invention; and

FIG. 2 illustrates a top view of a second section of school bus seating having an emergency exit side window and a seat back cover having a tactile feature according to the present invention.

### DESCRIPTION OF THE ILLUSTRATIVE EMBODIMENTS

For the purposes of promoting and understanding the principles of the invention, reference will now be made to one or more illustrative embodiments shown in the drawings and specific language will be used to describe the same. It will nevertheless be understood that no limitation of the scope of the invention is thereby intended.

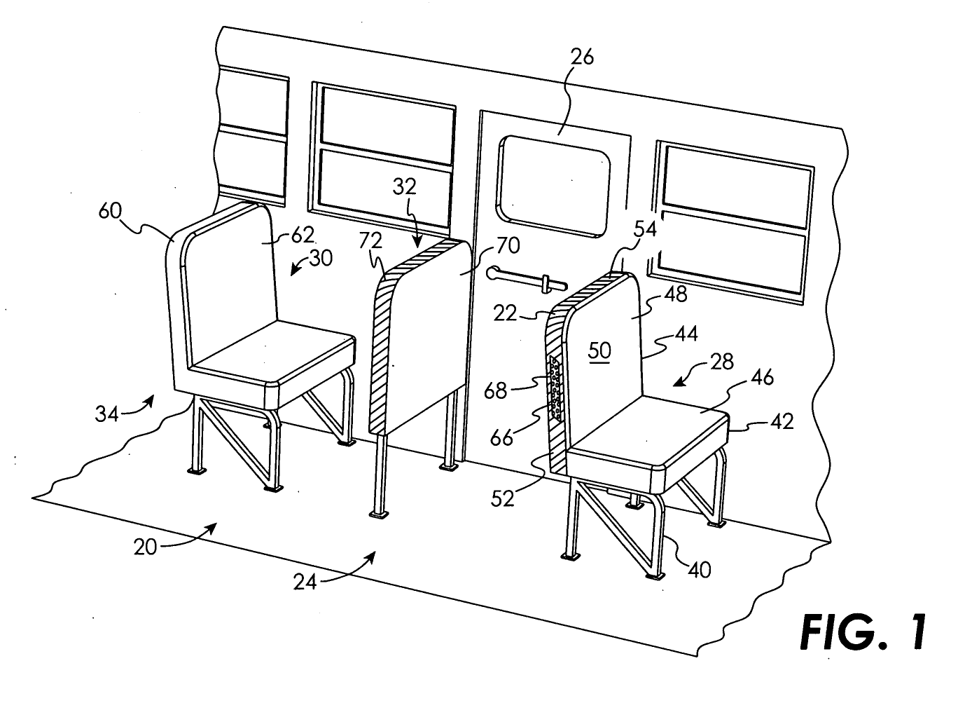

Referring to FIG. 1, an illustrative embodiment of a system 20 for marking emergency exits in passenger vehicles, for example a school bus, includes a tactile panel 22 located adjacent a path 24 to an emergency exit 26. School buses typically have one or more emergency exits in addition to the primary exits. Such emergency exits can comprise doors, hatches located in the ceiling, floor, or side wall, specially opening windows, and the like. Such an emergency exit 26 may be located between a forward seat 28 and a rear seat 30. An intervening barrier 32 may also be located between the seats 28 and 30 such that emergency exit 26 is located between the forward seat 28 and the barrier 32.

In the system 20 illustrated in FIG. 1, the tactile panel 22 that provides marking of the emergency exit 26 is associated with the forward seat 28, i.e., the seat immediately forward of the emergency exit 26. Advantageously, the panel 22 includes a tactile feature that allows occupants to use touch to easily distinguish the path 24 having an emergency exit 26 from other locations in the bus, for example a path 34 located behind rear seat 30, which do not have an emergency exit.

A typical school bus seat such as the forward seat 28 shown in FIG. 1, includes a support base 40, a seat bottom 42, and an upright seat back 44. The seat bottom 42 and the seat back 44 include covers 46 and 48, respectively. The seat covers 46 and 48 are generally constructed from a flexible, durable material, for example 42 oz. pigskin vinyl having a jersey knit backing. A typical seat cover 48 for the seat back 44 includes a front face 50, a rear face (not shown), and a strip panel 22. The strip panel 22 covers an aisle side 52, a top end 54, and a wall side (not shown) of the seat back 44. The strip panel 22 is typically sewn or otherwise coupled with the front face 50 and the rear face (not shown).

Advantageously, the strip panel 22 includes a tactile feature that distinguishes the forward seat 28 from the rear seat 30, thereby providing an evacuation aid that identifies the location of the emergency exit 26. For example, an illustrative embodiment of the seat cover 48 according to the present invention includes a strip panel 22 having tightly packed material loops that extend from the surface of the panel and that provide a much different tactile sensation when touched than is realized when touching other materials, including the vinyl typically used for the front face 50. An illustrative material used to form the strip panel 22 is 15 oz. polyester needle bond material having a latex backing.

In order to distinguish the feel or texture of the forward seat 28 located adjacent an emergency exit 26 from another seat, such as the rear seat 30, a strip panel 60 of a seat cover 62 associated with the rear seat 30 lacks the tactile feature associated with the strip panel 22. Thus, once an occupant is made aware that emergency exits are located adjacent to, behind, in front of, or between a seat(s) having a tactile featured strip panel 22, the emergency exit 26 can be located by an occupant based solely on the different tactile feel associated with the strip panels 22 and 60 of the forward seat 28 and the rear seat 30, respectively.

For example, in the illustrative embodiment system 20 shown in FIG. 1, the strip panel 22 is formed from about a 3 inch wide strip of fabric having loops protruding from it and the strip 60 is formed from the same vinyl material used to form the remainder of the covers 62 and 48. Thus, the cover 62 for the rear seat 30 can be a standard bus seat cover, while the cover 48 for the forward seat 28 provides an evacuation aid in the form of the tactile feature associated with the material used for the strip panel 22. The strip panel 22 may be, for example, constructed from a pliable, non-flammable, textured, durable fabric or non-fabric material. The tactile feature associated with the strip panel 22 may be a woven, molded, machined, stamped, or otherwise formed non-uniform surface associated with the strip panel 22.

In addition to or as an alternative to the tactile feature of the strip panel 22 being associated with the seat cover 48 as described above, a tactile feature may be associated with only a portion of the strip panel 22 or with another component of a seat 28. For example, the tactile feature may be associated with at least a portion of the aisle side 52 of panel 22, or with the entire back cover 48 of the forward seat 28, or with the entire back and bottom covers 46 and 48 of seat 28.

In further addition to or as a further alternative to the tactile features discussed above, a marking device 66 may be coupled to a portion of the forward seat 28, for example, the aisle side 52 of the seat back 44. For example, an illustrative embodiment of the marking device 66 includes a tactile feature 68 and may be securely coupled to the cover 48 or another portion of the seat 28. For example, the tactile feature 68 may be a woven, molded, machined, stamped, or otherwise formed non-uniform surface associated with the marking device 66. If such a marking device 66 is utilized, the strip panel 22 may be formed from the same material as the strip panel 60 of the rear seat 30, which may also be the same material used for the front face 50 and the cover 46 for the seat bottom 42. The marking device 66 may be, for example, constructed from a pliable, non-flammable, textured, durable fabric or non-fabric material.

In addition to or as a further alternative to the tactile feature associated with the strip panel 22 of the forward seat 28, the barrier 32 located adjacent the emergency exit 26 may also include a tactile feature, for example associated with a barrier strip panel 72 of a cover 70 for the barrier 32. For example, the cover 70 and the strip panel 72 may be constructed according to the various features discussed above for the strip panel 22 and cover 48 of the seat back 44 of the forward seat 28. A marking device 66 may additionally or alternatively provide the tactile feature associated with the barrier 32. As used herein, a “seat back” and “seat cover” is defined to include a barrier and a barrier cover, respectively.

In addition to or as a further alternative to the tactile feature associated with the strip panels 22 and 72 and marking device 66, one or more of the panels 22 and 72 and marking device 66 can also include an associated visual feature that distinguishes the forward seat 28 and/or the barrier 32 from the rear seat 30. For example, the strip panels 22 and 72 and the marking device 66 may include a different color or graphic design than is associated with the rear seat 30.

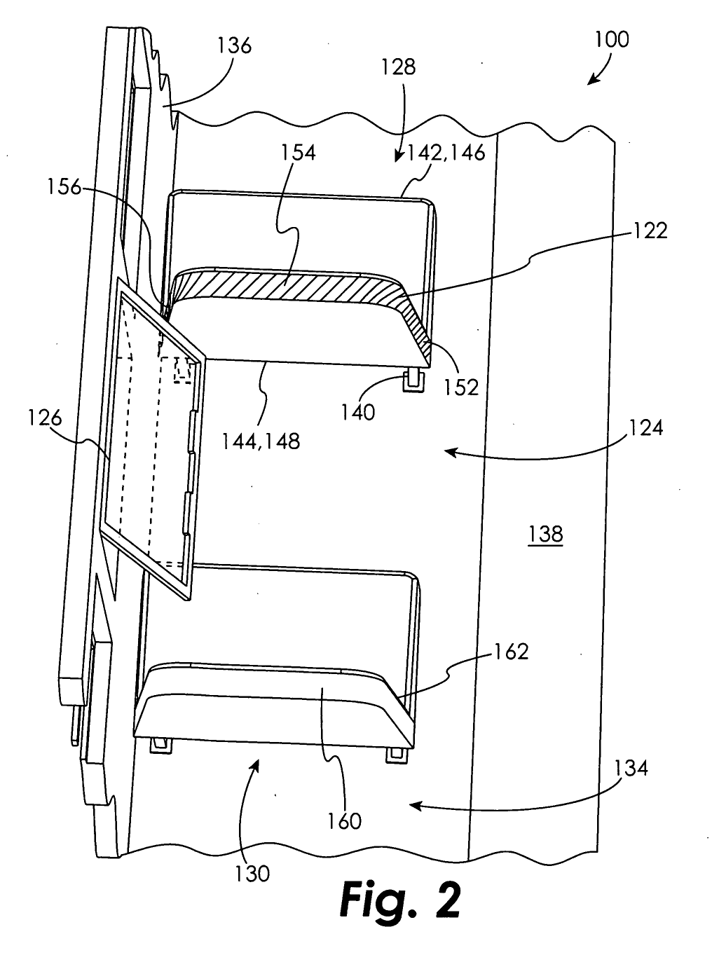

FIG. 2, a top view of a school bus, illustrates an embodiment comprising another illustrative system 100 for marking emergency exits in vehicles, for example a school bus, includes a tactile panel 122 located adjacent a path 124 to an emergency exit 126. The emergency exit 126 illustrated in FIG. 2 is a window that specially opens, for example, swings or detaches outwardly or inwardly from a side wall 136 of the bus. The emergency exit 126 is located between a forward seat 128 and a rear seat 130.

Advantageously, the tactile panel 122 allows occupants transiting the aisle 138 to use touch to easily distinguish the path 124 having an emergency exit 126 from other locations in the bus, for example a path 134 located behind rear seat 130, which does not have an emergency exit.

A typical school bus seat such as the forward seat 128 shown in FIG. 2, includes a support base 140, a seat bottom 142, and an upright seat back 144. The seat bottom 142 and seat back 144 include covers 146 and 148, respectively. The covers 146 and 148 are generally constructed from a flexible, durable material, for example 42 oz. pigskin vinyl having a jersey knit backing. A typical seat cover 148 for the seat back 144 includes a front face (not shown), a rear face 158, and a strip panel 122. The strip panel 122 covers an aisle side 152, a top end 154, and a wall side 156 of the seat back 144. The strip panel 122 can be sewn or otherwise coupled with the front face and the rear face 158.

In order to distinguish the feel or texture of the forward seat 128 located adjacent an emergency exit 126 from another seat, such as the rear seat 130, a strip panel 160 of a seat cover 162 associated with the rear seat 130 lacks the tactile feature associated with the strip panel 122. Thus, once an occupant is made aware that emergency exits are located adjacent to or behind a seat having a tactile featured strip panel 122, the emergency exit 126 can be located by an occupant based solely on the different tactile feel associated with the strip panels 122 and 160 of the forward seat 128 and the rear seat 130, respectively. For example, in the illustrative system 100 shown in FIG. 2, the strip panel 122 is formed from about a 3 inch wide strip of fabric having loops protruding from it and the strip 160 is formed from the same vinyl material used to form the remainder of the covers 162 and 148. Thus, the cover 162 for the rear seat 130 can be a standard bus seat cover, while the cover 148 for the forward seat 128 provides an evacuation aid in the form of the tactile feature associated with the material used for the strip panel 122.

In addition to or as an alternative to the features of described in illustrative system 100 above, the various features discussed for the illustrative system 20 may also be additionally or alternative included with the system 100.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected. For example, while illustrative system 20 and 120 associate the tactile feature with a bus seat located forward of an emergency exit, the tactile feature could alternatively or additionally be associated with a bus seat located behind, above, below, or on both sides of an emergency exit.

1. A marking device for a bus seat located adjacent an emergency exit, comprising:
a cover for the bus seat, the cover including a strip panel adapted to cover at least the top, the aisle side, and the wall side of the seat back, and a front panel adapted to cover at least the front face of the seat back; and
a tactile feature associated with the strip panel, the tactile feature capable of distinguishing the strip panel from the front panel upon human touch.

2. The marking device of claim 1, further comprising a visual feature associated with the strip panel, the visual feature capable of distinguishing the strip panel from the front panel upon human viewing.

3. The marking device of claim 1, wherein the tactile feature is a textured finish.

4. The marking device of claim 1, wherein the tactile feature includes a plurality of protrusions extending from the surface of at least a portion of the strip panel.

5. The marking device of claim 4, wherein the plurality of protrusions comprise material loops.

6. The marking device of claim 1, further comprising a marking panel coupled to the strip panel, the marking panel defining the tactile feature.

7. A system of marking emergency exits on a vehicle, comprising a device coupled to the seat back of only seats located adjacent an emergency exit, the device having a tactile feature that is discernable from the seat back upon human touch.

8. The system of claim 7, wherein the device comprises a cover portion for at least the top, aisle side, and wall side portions of a cover for the seat back.

9. The system of claim 7, further comprising a visual feature associated with the device, the visual feature capable of distinguishing the device from the seat back upon human viewing.

10. The system of claim 7, wherein the tactile feature is a textured finish.

11. The system of claim 7, wherein the tactile feature includes a plurality of protrusions extending from the surface of at least a portion of the device.

12. The system of claim 7, wherein the plurality of protrusions comprise material loops.

13. A vehicle emergency exit marking device for a vehicle seat, comprising a panel having a tactile feature and wherein:
the tactile feature is distinguishable from the seat upon human touch; and
the panel is coupled to the seat.

14. The vehicle emergency exit marking device of claim 13, wherein the tactile feature is a textured finish.

15. The vehicle emergency exit marking device of claim 13, wherein the panel comprises a portion of a cover of the seat.

16. The vehicle emergency exit marking device of claim 13, wherein the seat includes a seat back and the panel comprises the portion of the cover of the seat disposed over the aisle side, wall side, and top portion of the seat back.

17. The vehicle emergency exit marking device of claim 13, wherein the panel includes a visual feature and wherein the visual feature is distinguishable from the seat upon human viewing.

18. The vehicle emergency exit marking device of claim 13, wherein the seat includes a seat back and the panel is coupled to a portion of a cover of the seat disposed over an aisle side of the seat back.
